(19) United States
(12) Patent Application Publication
(10) Pub. No.: US 2007/0279389 A1
(43) Pub. Date: Dec. 6, 2007

(54) Method of task-oriented universal remote control user interface

(75) Inventors: Michael Hoch, Campbell, CA (US); Alan Messer, Los Gatos, CA (US); Yu Song, Pleasanton, CA (US); Mithun Sheshagiri, Berkeley, CA (US); Anugeetha Kunjithapatham, Sunnyvale, CA (US); Praveen Kumar, San Jose, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/444,994

(22) Filed: May 31, 2006

(51) Int. Cl. G09G 5/00

(52) U.S. Cl. 345/169

(57) ABSTRACT

A dynamic, flexible and intuitive task-oriented graphical user interface (GUI) is implemented on network accessible hand-held mobile devices. A mobile hand-held device is characterized by limited screen size and fewer input keys compared to a keyboard. In a home network environment, such mobile hand-held devices act as remote control devices for home devices. Typical examples of such remote control device are universal remote control and cell phone. In one implementation the GUI provides techniques for displaying large amounts of data using a small screen. The GUI also presents a technique for making the user aware of current abstract available options and smoothly guiding his current intention into a task selection that the remote control can understand and execute on.

### FIELD OF THE INVENTION

The present invention relates to universal remote controls, and in particular, to task-oriented universal remote control user interfaces.

### BACKGROUND OF THE INVENTION

With the proliferation of devices that can be controlled remotely, there is a need for graphical user interfaces (GUIs) that can be used to control such devices. In a home network, a single interface to control all home appliances is desirable as this reduces the cognitive load on the user to handle a different interface for each device. With the advance of hardware technology, devices with high resolution, albeit small display areas, and network connectivity are now available. Devices such as universal remote controls with display, smart phones and PDAs are well suited for controlling multiple devices.

Some conventional remote control solutions are device-based, meaning that they are either designed for specific type of devices, or a set of specific types of devices. In addition, the controlling methods of these solutions rely on the controlled device as a starting point. This means that a user must first navigate to find a desired device, and then control the device's functionalities. For example, a prior art remote control application on a PDA requires a user to select a device first. Once a user has selected a device, the application moves to next screens to let the user control the device (e.g., play, pause, rewind, stop, etc.).

Other conventional remote control solutions, on the other hand, let a user select desired content first (e.g., TV channels, TV programming guide, etc.), before a device is selected. However, in such solutions, there is an implicit assumption that the user has already selected the device that he is interacting with (i.e., the device where the contents display).

Yet other conventional remote control solutions map fixed activities (i.e., tasks) to buttons on the remote control for simplification. However, such fixed mapping is inflexible. Since the number of available tasks tends to change whenever devices are turned ON/OFF, the GUI has to be dynamic.

The conventional solutions that are device-centric have yet other disadvantages. For example, a wizard-style navigation guide that mandates a user to choose a device first is required. This, however, cannot be applied in the follows cases: (1) Given the devices available to the user, the user does not know what to do (user would prefer the network to suggest user-level tasks using the available devices, contents, his location or other relevant factors); (2) the user has selected a specific content. Given the number of devices that can operate on the selected content, he does not know what devices he should select, what activities can be performed on the content using the device and what he can do on the devices with the content.

### BRIEF SUMMARY OF THE INVENTION

In one embodiment the present invention provides a dynamic, flexible and intuitive task-oriented graphical user interface (GUI) for network accessible hand-held mobile devices. A mobile hand-held device is characterized by limited screen size and fewer input keys compared to a keyboard. In the home network environment, such mobile hand-held devices act as remote control devices for home devices. Typical examples of such remote control device are universal remote control and cell phone.

Another aspect of the present invention provides techniques for displaying large amounts of data using a small screen. This implementation also presents a technique for making the user aware of current available tasks and smoothly guides his current intention into a task selection.

A task-oriented universal remote control user interface according to the present invention provides dynamism for handling and adapting to changing number of devices, tasks and content in the network environment. The control user interface provides flexibility by allowing the user to start building an activity/task as he wishes. For example, the user can: first choose a device for his activity/task, first choose the content he wants to use, start from the location of the device, compose an activity using actions, etc. Actions are short representations of the task. The user interface is further user-friendly since the user's intention is captured as he goes about making his choices and the choices he makes are displayed in every screen. This allows the user to have the luxury of not having to remember the choices he has made.

These and other features, aspects and advantages of the present invention will become understood with reference to the following description, appended claims and accompanying figures.

### BRIEF DESCRIPTION OF THE DRAWINGS

FIG. 1 shows an example remote control unit implementing a task-oriented universal remote control user interface (GUI) according to an embodiment of the present invention.

FIG. 2 shows the remote control unit of FIG. 1 wherein the GUI displays a navigation menu according to an embodiment of the present invention.

FIG. 3 shows the remote control unit of FIG. 1 wherein the GUI displays a list view according to an embodiment of the present invention.

FIG. 4 shows a flowchart of steps of an example operation scenario of the GUI in the remote control of FIG. 1 according to an embodiment of the present invention.

FIG. 5 shows a functional block diagram that illustrates an example interaction between a remote control device and a controller that aggregates all the information in the home network and provides an interface mechanism, according to an embodiment of the present invention.

### DETAILED DESCRIPTION OF THE INVENTION

In one embodiment the present invention provides a dynamic, flexible and intuitive task-oriented graphical user interface (GUI) for network accessible hand-held mobile devices. A mobile hand-held device is characterized by limited screen size and fewer input keys compared to a keyboard. In the home network environment, such mobile hand-held devices act as remote control devices for home devices. Typical examples of such remote control device are universal remote control and cell phone.

In one implementation the present invention provides techniques for displaying large amounts of data using a small screen. This implementation also presents a technique for making the user aware of current abstract available options and smoothly guiding his current intention into a task selection that the remote control can understand and execute on.

A task-oriented universal remote control user interface according to the present invention provides dynamism for handling and adapting to changing number of devices, tasks and content in the network environment. The control user interface provides flexibility by allowing the user to start building an activity/task as he wishes. For example, the user can: first choose a device for his activity/task, choose the content he wants to use first, start from the location of the device, compose an activity using actions, etc. Actions are short representations of the task. The control user interface is further user-friendly since the user's intention is captured as he goes about making his choices and the choices he makes are displayed in every screen. This allows the user to have the luxury of not having to remember the choices he has made.

### Preferred Embodiment

As such, the present invention provides a control interface that includes a simple, intuitive graphic user interfaces (GUI) to remotely control a variety of devices to perform desired tasks in a home environment. Providing GUI according to the present invention involves provisioning of services to the user at a user-level abstraction and making the GUI adaptive enough to suit the needs of all users. Using this as the design principle, the following elaborates the features of an embodiment of the invention in a home network environment comprising network audio/visual (AV) devices.

### Definitions

The following definitions are used in this description.
Task: A task represents a high-level user centric activity that can be performed in a home network environment. Pseudo-sentences are to represent the task. A task phrase comprises a verb (e.g., Play), a subject (e.g., Music), a location (e.g., bedroom) and one or more devices (e.g., Hi-Fi Audio). A combination of verb and subject is called an “action”. Examples of actions are “Play Music” and “Print Picture”. The phrase “Play Music Hi-Fi Audio” is a typical example of a task. Examples of tasks and task generation are provided in commonly assigned patent application titled “Method and system for presenting user tasks for the control of electronic devices,” Ser. No. 10/947,774 filed on Sep. 22, 2004, and commonly assigned patent application titled “A method and system for describing consumer electronics using separate task and device descriptions,” Ser. No. 10/950,121 filed on Sep. 24, 2004, and commonly assigned patent application titled “A method and system for the orchestration of tasks on consumer electronics,” Ser. No. 10/948,399 filed on Sep. 22, 2004 (all incorporated herein by reference).
Controller: A Controller comprises a component that aggregates all the information in the home network and provides an interface mechanism. The interface mechanism acts as source of data to be displayed to the user and also as a mechanism to execute tasks by the devices in the home network.
Data-item: Data-item refers to the individual parts that make up the task. For example, subject, verb, location and action are data-items in an example scenario used to describe an implementation of the present invention.

### Dynamic and Adaptive GUI

A dynamic and adaptive GUI according to a preferred embodiment of the present invention implemented in an example home network is now described.

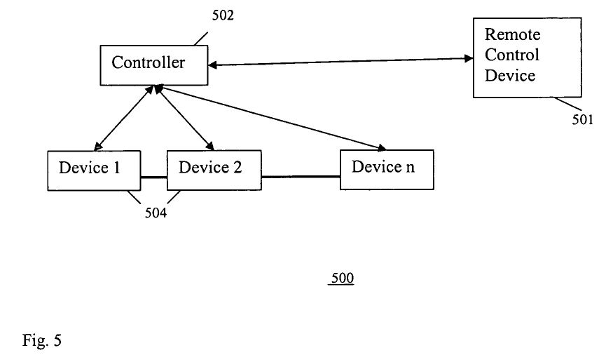

The home environment is ever changing with devices being constantly turned ON and OFF and content being added and removed all the time. A task always involves one or more devices and content. Therefore, the number of tasks in the system keeps changing. The example dynamic and adaptive control GUI according to present invention addresses this issue by dynamically rendering buttons and lists from data obtained from the controller: the controller keeps tab of the devices and content in the home network, generates the task and passes it on to the control GUI. An example of such controller interaction is shown in FIG. 5, described further below.

Each task also has a score calculated by the Controller. The list of tasks sent to the mobile device (e.g., remote control, cell phone, etc.) is prioritized based on the capabilities of the devices that make-up the task. Data-items of the task also acquire the score of the task. The GUI then renders all buttons and lists based on the score of data-items where data-items with higher scores appear on top. In this manner, the GUI always shows the best choice available to the user.

Tasks are calculated based on the location of devices and their capabilities. For example, if there are two tasks and both involve playing the video on one device and the audio on another device and both devices in the first task are in the same room whereas in the second task the devices are in different rooms, then the controller assigns a higher score to the former. Also, the controller knows the individual capabilities/features of each device and awards a higher score to devices with better capabilities. For example, if there are two audio devices and one supports stereo only and the other supports Dolby, then the controller scores tasks that use the second device higher than tasks that use the first device.

The various data-items (e.g., subject, verb, location, devices, etc.) sent by the Controller to the GUI are all linked by relationships determined by the Controller. For example, a Hi-Fi Audio device can only execute the “Play Music” action or a printer can only support the “Print” verb. The Controller encloses this relationship between the various data-items when it sends data to the GUI. While rendering the information, the GUI uses this relationship information to show tasks. While a user selects a particular data-item of a particular type, the GUI eliminates data-items of other types that are not compatible with the one chosen by the user. If the user selects “Hi-Fi Audio”, all subjects other than “Music” are disabled. The location where “Hi-Fi Audio” is located is automatically chosen by the GUI and other locations are disabled from being selected.

### Handling Small Screen Sizes

Limited screen size of mobile devices is a critical challenge addressed by the present invention. Any application of moderate complexity involves several types of data and some of these data types can have large number of instances. In the preferred embodiment, the present invention provides two techniques to address this issue.

Reducing Data-Types by Grouping
In one example, the number of data types is reduced by grouping together data-types. For example, action is an example of grouping where the verb and subject are grouped. Grouping verb and subject reduces the number of data-types by 1 and this reduction helps fit all the information on a single screen

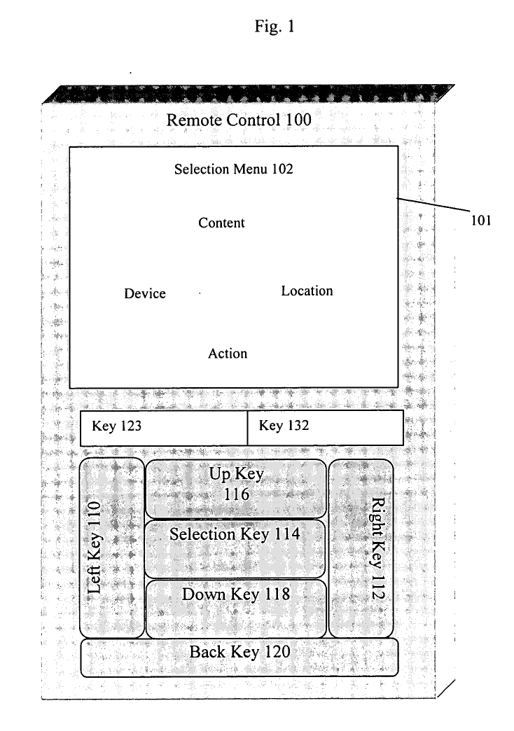

List View
Data-items like content are inherently large in number and a mechanism to handle this kind of data-item is desirable. The present invention provides an alternate list view for all items. The task composition screen (e.g., screen 101 in FIG. 1) shows different data-types available to the user (e.g., action, location, device, content, etc., in a home network scenario). The user can select an instance for each of these data-items e.g. by scrolling right-left. In this composition screen one instance of each data-type is shown. For displaying content which otherwise the user has to go through each instance one at a time, a list view is provided which displays several items in a separate screen.

### User-Friendliness

User has a mental model of how to go about achieving his goal (e.g., performing a task) and an intuitive GUI mimics the user's mental model. As different users can have different ways of achieving their goal, the present invention provides the user different ways of achieving a task, including the following alternatives:
1. Utilizing the GUI, the user first chooses the device to control. Once the device is chosen, the GUI asks the user to choose the action that he wants to perform on the chosen device. The third selection is the content. The GUI only displays content that is compatible with the device and action chosen. The location was already decided when the device was chosen using a many-to-one mapping between device and location. As such, by carefully choosing the order (i.e., listing location last), the user is guided through the selection process.
2. Utilizing the GUI, the user first chooses the action. The GUI then displays content on which this action can be performed. Once the content is chosen, the user can chose the locations where the chosen action can be performed on the chosen content. Finally, the user chooses the device that is compatible with his earlier choices.
3. Utilizing the GUI, the user first chooses the content, and then the GUI asks the user to choose the locations. The third selection is the device in the chosen location that can render the chosen content. Finally, the user selects the action he wants to perform using the choices he made earlier.
4. Utilizing the GUI, the user first chooses the location. Then, the GUI asks the user to choose the devices in that location. Then the GUI asks the user to choose the action that can be performed on the device. Finally, the user chooses the content for his task.

The GUI does not force a user to select any of these alternatives first. The user has the freedom to choose in any order. This is a natural and flexible way of addressing the different needs of users in an environment with multiple heterogeneous devices and a variety of contents.

By grouping together data-items, the GUI displays all the choices made by the user at all times. Further, by displaying all choices made by the user, the GUI reduces the load on the user by eliminating the need to remember things he chose and simplifies the task composition process. Fewer data-items also means that almost all relevant information can be displayed on the same screen, thereby reducing context switching caused by changing screens.

### EXAMPLE IMPLEMENTATION

With a variety of devices and contents, tasks that can be operated over devices and contents. For example, a TV allows a user to: (1) watch movie, (2) watch photo slide show, (3) listen to music, etc. To cope with such device multi-functionalities, and a variety of contents, a remote control interface that allows the user to suggest “what” and “where” he wants to do is provided. The interface is also suitable for remote controls that have small display screens as reducing number-key navigation is as important as providing intuitive graphics.

The example implementation below provides a simple, intuitive, graphic user interface (GUI) for remote controls that have small display screen. The GUI allows a user to select actions, contents, locations and devices in any order to reach his goals with reduced/minimum navigation keys.

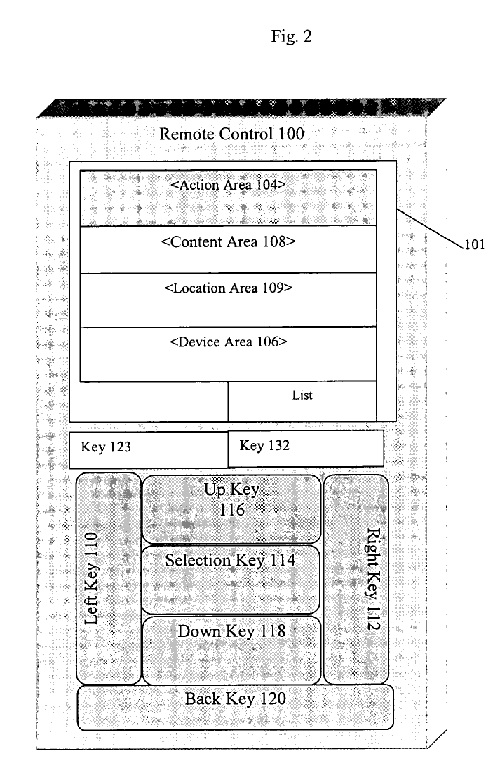

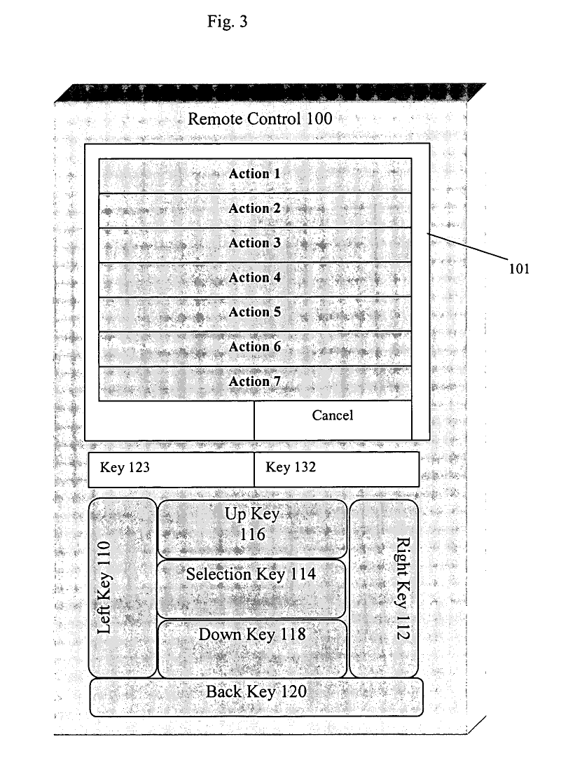

Referring to FIGS. 1-3, an example remote control 100 with a small screen 101 implements an example GUI according to an embodiment of the present invention, the GUI comprising: (1) a selection menu 102 (FIG. 1) displayed on the screen 101 that allows a user to select either action, location, content or devices, as the entry point into directing the devices to perform a task; (2) action display area 104 (FIG. 2) that shows the available actions; (3) a device display area 106 that shows the available devices; (4) a content display area 108 that shows the available contents; (5) a location display area 109 that shows various locations for devices in the home environment; (6) a left key 110 and a right key 112 to navigate the available tasks, contents, and devices; (7) a selection key 114 to confirm a user selection; (8) a up key 116 and a down key 118 to navigate among task area, device area and content area; and (9) a back key 120 to let the user to jump back to the selection menu. Further, FIG. 3 shows an example of list view described above on the remote control 100. Activating the “List” button takes the user to the screen on display 101 shown in FIG. 3. One can get back to screen shown on display 101 in FIG. 2 by activating “Cancel” button in FIG. 3.

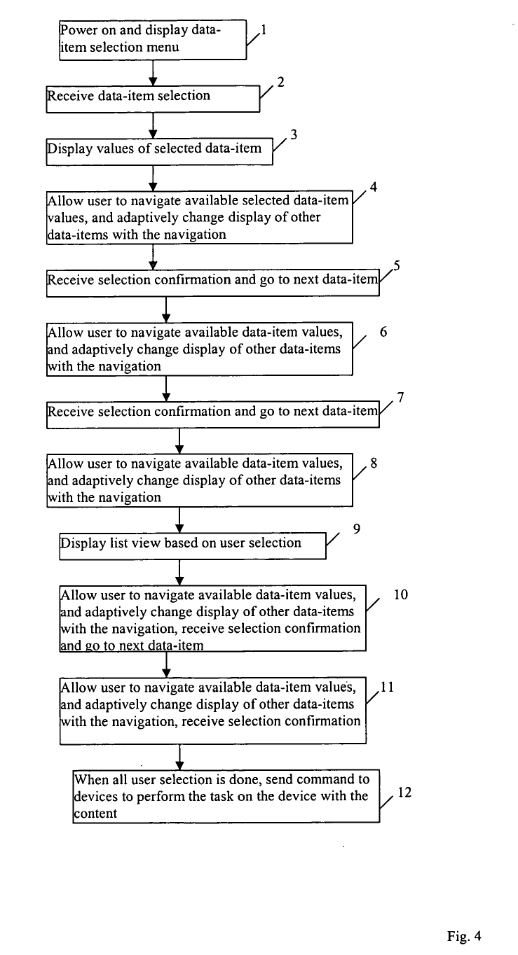

Referring to the flowchart in FIG. 4, an example operation of the example remote control 100 implementing the GUI displayed in screen 101, includes the following steps 1-12:
1. When a user powers on the remote control 100, the selection menu 102 is first displayed (FIG. 1). The selection menu 102 contains four items: action, devices, locations and contents. Each of these items is mapped to buttons based on their position on the screen. For example, the content can be selected as the starting point by selecting the up key 116, while the location can be selected by activating the right key 112. A user is free to select any of these items.
2. A user selects one of said four items by pressing one of the directional keys.
3. The remote control 100 goes to the next screen (FIG. 2) wherein the values for the four items are displayed. The screen 101 contains four areas: action area 104, device area 106, location area 109 and content area 108. In this example, the user has selected an action to start with, and as such the action area 104 is highlighted (FIG. 2). The action area 103 shows one of the available actions based on available locations, devices and contents in the home network.
4. The user uses the left key 110 and right key 112 to navigate the available actions, and adaptively change other data-item areas displayed based on the user navigation. As such, each time, the user navigates to a different action, the device area 106, location area 109 and content area 108 change to show one of the available devices and contents that are compatible with the displayed action. As such, when an action is displayed, the best device (or devices) in the best location that can perform the chosen task is displayed, content that is relevant to the chosen action and that can be used by the device is displayed and location of the device is also displayed.
5. The user uses the down key 116 to navigate to the device area 106 and confirm the action selection above.
6. As with the task action area 104, the user can use left key 110 and right key 112 to navigate the available tasks. Each time the user navigate to a different device, the lower areas on screen 101 such as the content area 108 may change to display different content that matches the selected task and the selected device.
7. The user uses the down key 118 to navigate to the content area 108. The down key (button) 118 performs two operations—selecting the device and scrolling down to the content area 108.
8. As with the task action area 104, the user can use left key 110 and right key 112 to navigate the content area 108, and then use the down key 118 to confirm content selection and navigate to the location area 109.
9. In all areas (particularly the content area 108) the user is able to bring up a list view to more easily navigate the large amount of data using the “List” button in FIG. 2. FIG. 3 shows an example list view for actions when the list button is mapped to key 132. This provides a view where multiple instances are displayed to the user. The user can go back to the previous/regular view by pressing key 132 again.
10. As with the task content area 108, the user can use left key 110 and right key 112 to navigate the location area 109, and then use the down key 118 to confirm content selection and navigate to the device area 106.
11. As with the task location area 109, the user can use left key 110 and right key 112 to navigate the device area 106.
12. Finally, the user performs the task by using the select button 114. Once selected, the remote control 100 sends command to devices to perform the task on the device with the content.

The steps of navigating values of a selected data-item with adaptive change in display of other data-item values can continue until all available data-items have been selected.

The above example steps describe the controlling steps in a case that user selects the action first. The GUI, however, does not force a user to select the action first in the first selection screen (FIG. 1). A user is free to select either device or content first in the selection menu. Even in the middle of the selection in the second screen (FIG. 2), the user is free to go back to the selection screen (FIG. 1) to start over again with different selections.

The order of transitions from Action to Location to Device to Content differs depending on what is selected at the starting point in the first screen and the local cultural semantics of forming logical relationships between concepts to build user intent. By using the task pseudo sentence elements (e.g., verb, subject, etc.) and having a logical order for selection based on the first selection screen, the user is able to read and logically understand the interaction so as to smoothly be guided through determining user intent.

FIG. 5 shows a functional block diagram of an example network 500 that embodies aspects of the present invention. The network 500 includes devices a remote control 501, a controller 502 and devices 504 interconnected as shown. FIG. 5 illustrates an example interaction between the remote control device 501 and the controller 500 that aggregates all the information in the home network devices 504 and provides an interface mechanism, according to an embodiment of the present invention. The double headed arrows in FIG. 5 indicate command/information exchange between the remote control 501 and the controller 502, and between the controller 502 and the devices 504.

As those skilled in the art recognize, the techniques described herein have universal appeal that can be used in non-home network environments. The example GUI embodiments described herein are for devices in a home network for control by remote control devices. The GUI can be implemented in a cell phone or other mobile device.

The present invention has been described in considerable detail with reference to certain preferred versions thereof; however, other versions are possible. Therefore, the spirit and scope of the appended claims should not be limited to the description of the preferred versions contained herein.

What is claimed is:

1. A task-oriented universal remote control interface, comprising:
a user interface for receiving user input for exploring tasks in a network;
a controller that aggregates information in the network into tasks for display by the user interface;
wherein:
the user interface receives user selection of displayed tasks to remotely control a variety of devices to perform desired tasks; and
the controller executes user selected tasks on one or more of a plurality of devices in the network.

2. The remote control interface of claim 1, wherein:
the controller aggregates information in the network into available task choices;
the user interface dynamically updates the task choices available to the user based at least on the user input, thereby effectively guiding the user input.

3. The remote control interface of claim 2, wherein:
the controller aggregates information in the network into available task choices, said information including one or more of: user location, available actions, available content and available devices in the network.

4. The remote control interface of claim 3, wherein:
the user interface dynamically updates the task choices available to the user based on the user input and one or more of user location, available actions, available content and available devices in the network, thereby effectively guiding the user input.

5. The remote control interface of claim 3, wherein the controller adaptively aggregates information in the network into available task choices to reflect changing status of the network.

6. The remote control interface of claim 3, wherein the controller adaptively aggregates information in the network into available task choices to reflect changing actions, content, number and status of devices in the network.

7. The remote control interface of claim 4 wherein user interface allows the user to first choose a device for his task.

8. The remote control interface of claim 4 wherein user interface allows the user to first choose content for his task.

9. The remote control interface of claim 4 wherein user interface allows the user to first choose a device for his task.

10. The remote control interface of claim 4 wherein user interface allows the user to start from the location of a device and compose an activity to be performed by the network.

11. The remote control interface of claim 1 wherein a task represents a high-level user centric activity that can be performed in the network.

12. A task-oriented universal remote control interface, comprising:
a user interface for receiving user input for exploring tasks in a network, wherein a task comprises individual data-items;
a controller that aggregates information in the network into tasks for display by the user interface;
wherein:
the user interface receives user selection of displayed tasks to remotely control a variety of devices to perform desired tasks; and
the controller executes user selected tasks on one or more of a plurality of devices in the network.

13. The remote control interface of claim 12 wherein tasks are represented by pseudo-sentences.

14. The remote control interface of claim 13 wherein a task phrase comprises a verb, a subject, a location and one or more devices.

15. The remote control interface of claim 14 wherein a combination of verb and subject represents an action.

16. The remote control interface of claim 12 wherein each task also has a score calculated by the controller.

17. The remote control interface of claim 16 wherein data-items of a task also acquire the score of the task.

18. The remote control interface of claim 16 wherein the user interface dynamically renders selection buttons on the remote control interface based on information dynamically gathered by the controller.

19. The remote control interface of claim 18 wherein the user interface dynamically renders buttons and tasks lists based on the score of data-items.

20. The remote control interface of claim 18 wherein the user interface always shows the best task choice available to the user.

21. The remote control interface of claim 12 wherein the tasks displayed by the user interface are prioritized based on the capabilities of the devices that make-up the task.

22. The remote control interface of claim 21 wherein data-items sent by the controller to the user interface are all linked by relationships determined by the controller.

23. The remote control interface of claim 21 wherein the controller encloses this relationship between the various data-items when the data-items are sent to the user interface.

24. The remote control interface of claim 23 wherein while rendering the data-items, the user interface uses this relationship information to show tasks.

25. The remote control interface of claim 24 wherein while a user selects a particular data-item of a particular type, the user interface eliminates data-items of other types that are not compatible with the one chosen by the user.
